(19) United States
(12) Patent Application Publication
(10) Pub. No.: US 2026/0289405 A1
(43) Pub. Date: Sep. 24, 2026

(54) DATA RECOGNITION DEVICE, DATA RECOGNITION METHOD, AND RECORDING MEDIUM

(71) Applicant: NEC Corporation, Tokyo (JP)

(72) Inventors: Kotaro MURASE, Tokyo (JP); Shumpei SHIMOMURA, Tokyo (JP); Yuichi NAKATANI, Tokyo (JP)

(21) Appl. No.: 19/557,718

(22) Filed: Mar. 5, 2026

(30) Foreign Application Priority Data
Mar. 18, 2025 (JP) 2025-044017

(51) Int. Cl. G06N 20/00

(52) U.S. Cl. CPC G06N 20/00

(57) ABSTRACT

A data recognition device includes a feature amount generation unit, an estimation unit, an estimation result integration unit, and an output unit. The feature amount generation unit generates an integrated feature amount that is a feature amount obtained by integrating an initial estimation result that is an estimation result by each individual estimation model that estimates content of data and an additional feature amount that is a feature amount extracted from the data. The estimation unit estimates the content of the data to be estimated, from the integrated feature amount generated based on the initial estimation result of the individual estimation model related to each estimation model, using the estimation models that estimate the content of the data from the integrated feature amount. The estimation result integration unit integrates estimation results of the estimation models. This configuration further enables AI-driven rapid and accurate decision making in diverse data-recognition scenarios.

### CROSS-REFERENCE TO RELATED APPLICATION

This application is based upon and claims the benefit of priority from Japanese Patent Application No. 2025-44017, filed on Mar. 18, 2025, the disclosure of which is incorporated herein in its entirety by reference.

### TECHNICAL FIELD

The present disclosure relates to a data recognition device or the like.

### BACKGROUND ART

As a method for improving an accuracy of a result of data recognition, for example, a method for recognizing data using a plurality of machine learning models may be used.

An inference device in JP 2023-156633 A extracts a plurality of feature amounts from an image to be identified and identifies the image based on each of the plurality of feature amounts. Then, the inference device in JP 2023-156633 A integrates a plurality of identification results.

### SUMMARY

An object of the present disclosure is to provide a data recognition device or the like capable of improving data recognition accuracy.

A data recognition device according to an aspect of the present disclosure includes feature amount generation unit that generates an integrated feature amount that is a feature amount obtained by integrating an initial estimation result that is an estimation result by each individual estimation model that estimates content of data to be estimated and an additional feature amount that is a feature amount extracted from the data to be estimated, estimation unit that estimates the content of the data to be estimated, from the integrated feature amount generated based on the initial estimation result of the individual estimation model related to each of a plurality of estimation models, using the plurality of estimation models that estimates the content of the data to be estimated from the integrated feature amount, estimation result integration unit that integrates estimation results of the plurality of estimation models, and output unit that outputs the integrated estimation result.

A data recognition method according to an aspect of the present disclosure includes generating an integrated feature amount that is a feature amount obtained by integrating an initial estimation result that is an estimation result by each individual estimation model that estimates content of data to be estimated and an additional feature amount that is a feature amount extracted from the data to be estimated, estimating the content of the data to be estimated, from the integrated feature amount generated based on the initial estimation result of the individual estimation model related to each of a plurality of estimation models, using the plurality of estimation models that estimates the content of the data to be estimated from the integrated feature amount, integrating estimation results of the plurality of estimation models, and outputting the integrated estimation result.

A non-transitory recording medium according to an aspect of the present disclosure records a program for causing a computer to execute processing for generating an integrated feature amount that is a feature amount obtained by integrating an initial estimation result that is an estimation result by each individual estimation model that estimates content of data to be estimated and an additional feature amount that is a feature amount extracted from the data to be estimated, processing for estimating the content of the data to be estimated, from the integrated feature amount generated based on the initial estimation result of the individual estimation model related to each of a plurality of estimation models, using the plurality of estimation models that estimates the content of the data to be estimated from the integrated feature amount, processing for integrating estimation results of the plurality of estimation models, and processing for outputting the integrated estimation result.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a data recognition system according to an example embodiment of the present disclosure;

FIG. 2 is a diagram illustrating an example of a configuration of data recognition according to the example embodiment of the present disclosure;

FIG. 3 is a diagram schematically illustrating an example of a data flow according to the example embodiment of the present disclosure;

FIG. 4 is a diagram schematically illustrating an example of the data flow according to the example embodiment of the present disclosure;

FIG. 5 is a diagram schematically illustrating an example of the data flow according to the example embodiment of the present disclosure;

FIG. 6 is a diagram schematically illustrating an example of the data flow according to the example embodiment of the present disclosure;

FIG. 7 is a diagram illustrating an example of an operation flow of a data recognition device according to the example embodiment of the present disclosure;

FIG. 8 is a diagram illustrating an example of the operation flow of the data recognition device according to the example embodiment of the present disclosure;

FIG. 9 is a diagram illustrating an example of the operation flow of the data recognition device according to the example embodiment of the present disclosure;

FIG. 10 is a diagram illustrating an example of the operation flow of the data recognition device according to the example embodiment of the present disclosure;

FIG. 11 is a diagram illustrating an example of the operation flow of the data recognition device according to the example embodiment of the present disclosure; and

FIG. 12 is a diagram illustrating an example of a configuration of hardware of the data recognition device according to the example embodiment of the present disclosure.

### EXAMPLE EMBODIMENT

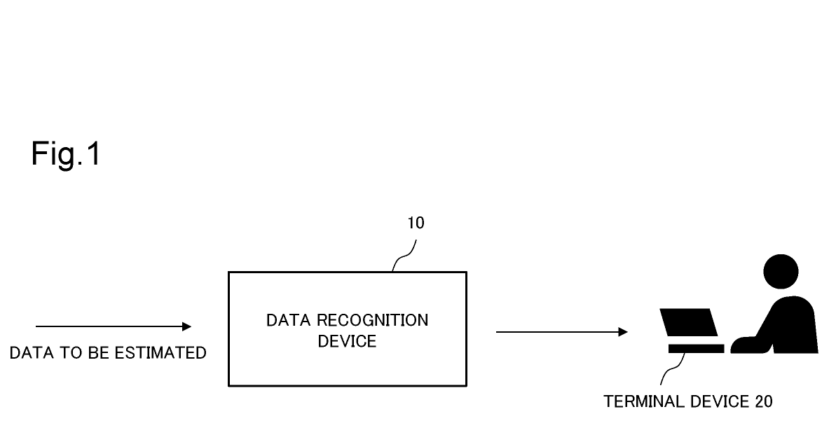

Example embodiments of the present disclosure will be described in detail with reference to the drawings. FIG. 1 is a diagram illustrating an example of a configuration of a data recognition system. The data recognition system includes, for example, a data recognition device 10 and a terminal device 20. The data recognition device 10 is connected to the terminal device 20, for example, via a network. The plurality of terminal devices 20 may be provided. The number of terminal devices 20 can be appropriately set.

The data recognition system is, for example, an information processing system that estimates content of data. Estimating the content of the data means, for example, estimating what data to be estimated relates to. For example, in a case where the data to be estimated is an image in which an object is imaged, the data recognition system estimates classification of the object. For example, in a case where the data to be estimated is an image in which a sentence is imaged, for example, the data recognition system estimates the sentence imaged in the image. The content of the data to be estimated in a case where the data to be estimated is the image data is not limited to the above. For example, in a case where the data to be estimated is voice data, estimating the content of the data means estimating information indicated by the voice data. The content of the data to be estimated in a case where the data to be estimated is the voice data is not limited to the above. For example, in a case where the data to be estimated is a measurement result by a sensor, the content of the data to be estimated is characteristics of a measurement target. In a case where the content of the data to be estimated is the measurement result by the sensor, the content of the data to be estimated is not limited to the above. The content of the data to be estimated is not limited to the above.

For example, the data recognition system generates an integrated feature amount that is a feature amount obtained by integrating an initial estimation result that is an estimation result of the content of the data to be estimated by each of a plurality of individual estimation models and a feature amount extracted from the data. The individual estimation model is, for example, a machine learning model that estimates content of data, using the data to be estimated as an input. For example, the data recognition system generates the integrated feature amounts as many as the number of individual estimation models used for estimation. Then, the data recognition system estimates the content of the data to be estimated, based on the integrated feature amount, for example, using an estimation model related to each individual estimation model. The data recognition system estimates the content of the data to be estimated, for example, using the plurality of estimation models related to the individual estimation model. Each estimation model is, for example, a machine learning model that estimates content of data used to generate the integrated feature amount, using the integrated feature amount as an input. For example, the data recognition system integrates estimation results by the plurality of estimation models and outputs the integrated estimation result as an estimation result of the content of the data to be estimated.

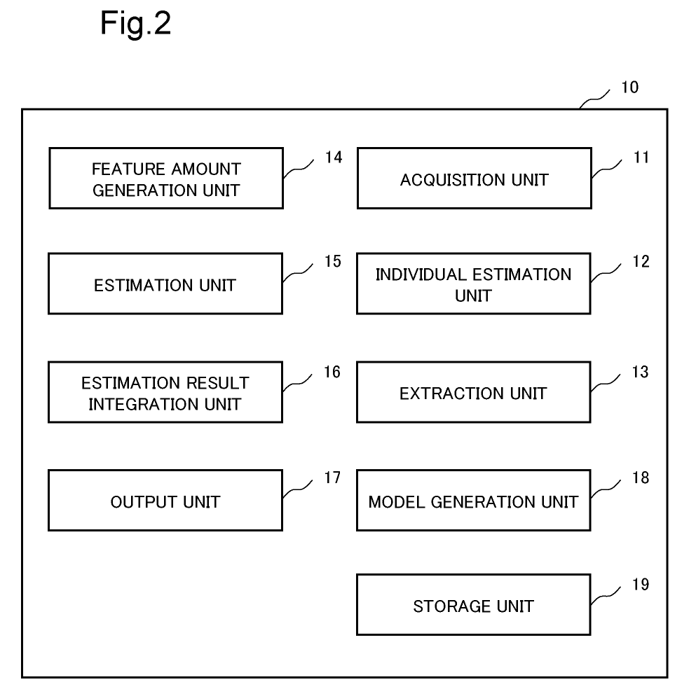

Here, an example of a configuration of the data recognition device 10 will be described. FIG. 2 is a diagram illustrating an example of the configuration of the data recognition device 10. The data recognition device 10 includes a feature amount generation unit 14, an estimation unit 15, an estimation result integration unit 16, and an output unit 17, as basic configurations. For example, the data recognition device 10 may further include an acquisition unit 11, an individual estimation unit 12, an extraction unit 13, a model generation unit 18, and a storage unit 19.

For example, the acquisition unit 11 acquires the data to be estimated. The data to be estimated is, for example, data of which content of data is to be estimated. The data to be estimated is, for example, an image, voice, or measurement data by a sensor. In a case where the data to be estimated is image data, the data to be estimated is, for example, data of an image in which an object or a character to be estimated is imaged. In a case where the data to be estimated is voice data, the data to be estimated is, for example, data of voice expressing information. In a case where the data to be estimated is the measurement data by the sensor, the data to be estimated is, for example, time-series data of a measurement value of the sensor. The data to be estimated is not limited to the above. For example, the acquisition unit 11 acquires the data to be estimated from the terminal device 20. The acquisition unit 11 may acquire the data to be estimated, from an information processing device (not illustrated) connected via the network.

The acquisition unit 11 may acquire information for specifying the individual estimation model used to estimate the content of the data to be estimated, from among the plurality of individual estimation models. The information for specifying the individual estimation model used to estimate the content of the data to be estimated is, for example, input to the terminal device 20 by a user’s operation. The user is, for example, a person who uses an estimation result of the content of the data to be estimated. For example, the acquisition unit 11 acquires the information for specifying the individual estimation model used to estimate the content of the data to be estimated, from the terminal device 20.

In a case where the model generation unit 18 generates the estimation model and an integrated model, for example, the acquisition unit 11 acquires training data used to generate the estimation model and the integrated model. The training data is, for example, data in which the same type of data as the data to be estimated and ground truth data having content of the data are associated. For example, the acquisition unit 11 acquires the training data, from the terminal device 20. The acquisition unit 11 may acquire the training data, from the information processing device (not illustrated) connected via the network.

The individual estimation unit 12 estimates the content of the data to be estimated acquired by the acquisition unit 11, for example, using the plurality of individual estimation models that estimates the content of the data to be estimated. Each of the plurality of individual estimation models is, for example, a machine learning model that estimates the content of the data to be estimated, using the data to be estimated as an input. Each of the plurality of individual estimation models outputs, for example, the estimation result of the content of the data to be estimated, as an initial estimation result. The respective individual estimation models are generated, for example, using algorithms different from each other. The respective individual estimation models may be machine learning models that identify an object based on features different from each other. For example, an individual estimation model that identifies an object based on a feature of an outer shape and an individual estimation model that identifies an object based on a surface pattern of the object may be used. The respective individual estimation models may be machine learning models generated using pieces of the training data different from each other.

The individual estimation unit 12 may estimate the content of the data to be estimated, using the individual estimation model specified by the information for specifying the individual estimation model used to estimate the content of the data to be estimated, from among the plurality of individual estimation models.

In a case where an information processing device outside the data recognition device 10 estimates the content of the data using the individual estimation model, the acquisition unit 11 acquires an estimation result of the content of the data, for example, from the information processing device that performs the estimation by the individual estimation model. In a case where the estimations by the plurality of individual estimation models are performed in the information processing devices different from each other, for example, the acquisition unit 11 acquires the estimation result of the content of the data, from each information processing device that performs estimation by the individual estimation model.

For example, the extraction unit 13 extracts a feature amount from the data to be estimated acquired by the acquisition unit 11, as an additional feature amount. The additional feature amount is, for example, a feature amount regarding the classification of the data to be estimated by the individual estimation model or the characteristics. The extraction unit 13 may extract the additional feature amount of the data to be estimated, at an intermediate stage of the estimation by the individual estimation model. In a case where the data to be estimated is estimated using a neural network, for example, the extraction unit 13 extracts an output of an intermediate layer of the neural network as the additional feature amount. The extraction unit 13 may extract the additional feature amount from the data to be estimated, using an extraction model. The extraction model is, for example, a machine learning model that extracts the additional feature amount, from the data to be estimated. The extraction model is generated by deep learning using the neural network, for example. A machine learning algorithm for generating the extraction model is not limited to the above.

In a case where the data to be estimated is the image data, the additional feature amount is, for example, a feature amount representing a feature of an object imaged in the image. In a case where the data to be estimated is the image data, for example, the extraction unit 13 extracts information regarding one or a plurality of items of a size, a length, a shape, and a color of the object imaged in the image, as the additional feature amount. For example, in a case where a dog type is estimated from an image in which a dog is imaged, the extraction unit 13 extracts information regarding one or a plurality of items of a trunk length, a tail length, a leg length, and a color, as the additional feature amount. The additional feature amount in a case where the dog type is estimated is not limited to the above. In a case where the data to be estimated is the image data, the extraction unit 13 may extract characteristics of the image as the additional feature amount. The characteristics of the image are, for example, information regarding one or a plurality of items of a brightness, a chromaticity, a contrast, and a resolution of the image. The characteristics of the image extracted as the additional feature amount are not limited to the above. The additional feature amount in a case where the data to be estimated is the image is not limited to the above.

In a case where the data to be estimated is the voice data, for example, the additional feature amount is a feature amount representing a feature of the voice data. In a case where the data to be estimated is the voice data, the extraction unit 13 extracts, for example, data of one or a plurality of items of a frequency and an intensity of the voice data, and an interval of the data as the additional feature amount. The additional feature amount in a case where the data to be estimated is the voice data is not limited to the above. In a case where the data to be estimated is the measurement data by the sensor, for example, the additional feature amount is a feature amount representing a feature of the measurement data. In a case where the data to be estimated is the measurement data by the sensor, for example, the extraction unit 13 extracts the data of the one or the plurality of items of the frequency and the intensity of the measurement data and the interval of the data, as the additional feature amount. The additional feature amount in a case where the data to be estimated is the measurement data by the sensor is not limited to the above.

In a case where the feature amount of the data to be estimated is extracted by an information processing device outside the data recognition device 10, for example, the extraction unit 13 acquires a feature amount extracted from the data to be estimated, from the information processing device that operates as an extractor for extracting the feature amount of the data to be estimated. In a case where the feature amount of the data to be estimated is extracted in an estimation process by the individual estimation model, for example, the extraction unit 13 acquires the feature amount of the data to be estimated, from the information processing device that performs estimation by the individual estimation model.

The feature amount generation unit 14 generates the integrated feature amount that is a feature amount obtained by integrating the initial estimation result that is the estimation result by each individual estimation model that estimates the content of the data to be estimated and the additional feature amount extracted from the data to be estimated.

For example, the feature amount generation unit 14 generates the integrated feature amount by integrating the estimation result by each individual estimation model and the additional feature amount in association with each other. For example, the feature amount generation unit 14 converts the estimation result by each individual estimation model into a feature vector. The extraction unit 13 converts the additional feature amount of the data to be estimated into the feature vector. Then, the feature amount generation unit 14 generates the feature vector indicating the integrated feature amount related to the estimation result of each individual estimation model, based on the feature vector converted from the estimation result and the feature vector converted from the additional feature amount. In a case where the additional feature amount is extracted as the feature vector by the extraction unit 13, the feature amount generation unit 14 may generate the feature vector indicating the additional feature amount, based on the feature vector converted from the estimation result and the feature vector extracted by the extraction unit 13.

For example, the feature amount generation unit 14 generates the integrated feature amount by integrating the same additional feature amount with the estimation result of each individual estimation model. For example, the feature amount generation unit 14 may generate the integrated feature amount by integrating the additional feature amount related to each individual estimation model, with the estimation result of each individual estimation model.

The feature amount generation unit 14 may generate the integrated feature amount using the feature amount extracted at the intermediate stage of the estimation by the individual estimation model as the additional feature amount. For example, in a case where the individual estimation model is generated using the neural network, the feature amount generation unit 14 generates the integrated feature amount using the output in the intermediate layer as the additional feature amount.

The estimation unit 15 estimates the content of the data to be estimated, from the integrated feature amount generated based on the estimation result of the individual estimation model related to each of the plurality of estimation models, using the plurality of estimation models for estimating the content of the data to be estimated from the integrated feature amount. The estimation model is a machine learning model that estimates the content of the data to be estimated, for example, using the integrated feature amount as an input. The estimation model is generated, for example, in such a way as to relate to the individual estimation model. For example, the estimation model is generated in such a way that an individual estimation model A is related to an estimation model A and an individual estimation model B is related to an estimation model B. In such a case, for example, the estimation unit 15 inputs an integrated feature amount A generated from an initial estimation result A by the individual estimation model A into the estimation model A and inputs an integrated feature amount B generated from an initial estimation result B by the individual estimation model B into the estimation model B in such a way as to estimate the content of the data to be estimated.

For the estimation model, for example, a machine learning model generated by deep learning using the neural network is used. For the estimation model, a machine learning model generated using a decision tree method may be used. For the estimation model, a machine learning model using a random forest method may be used. By using the machine learning model using the decision tree method or the machine learning model using the random forest method, for example, the estimation unit 15 can extract a reason for estimating the content of the data to be estimated from a feature amount that has larger influence on the estimation result than other feature amounts. The machine learning algorithm used to generate the estimation model is not limited to the above.

The estimation result integration unit 16 integrates the estimation results of the plurality of estimation models. Integrating the estimation results means, for example, obtaining one estimation result regarding the content of the data to be estimated, based on the estimation results of the plurality of estimation models. Integrating the estimation results may be, for example, generating information indicating the estimation result of each of the plurality of estimation models and accuracy of each estimation result. The estimation result integration unit 16 specifies the content of the data to be estimated, for example, by integrating the estimation results of the plurality of estimation models.

The estimation result integration unit 16 may integrate the estimation results of the plurality of estimation models by specifying the content of the data, using the integrated model. For example, the integrated model is a machine learning model that specifies the content of the data from the estimation results of the plurality of estimation models. For the integrated model, for example, a machine learning model generated by deep learning using the neural network is used. A machine learning algorithm for generating the integrated model is not limited to the above.

The estimation result integration unit 16 may use the most frequent estimation results, among the estimation results of the plurality of estimation models, as the estimation result. For example, the estimation result integration unit 16 integrates the estimation results of the plurality of estimation models by specifying the estimation result by a majority vote using the estimation result of each of the plurality of estimation models. The estimation result integration unit 16 may integrate the estimation results of the plurality of estimation models by specifying the estimation result by weighting the estimation result of each of the plurality of estimation models.

The output unit 17 outputs the integrated estimation result. The output unit 17 outputs the integrated estimation result, for example, to the terminal device 20. The output unit 17 may output the estimation result of each of the plurality of estimation models. The output unit 17 may further output the reason for estimating the content of the data. For example, the output unit 17 may output the reason for estimating the content of the data, based on a portion focused by the individual estimation model in the estimation.

The output unit 17 may output data of a display screen for specifying the individual estimation model used to estimate the content of the data to be estimated. For example, the output unit 17 outputs data of a display screen including a list of individual estimation models that can be specified and an input field of a selection result of the individual estimation model used for estimation. For example, the output unit 17 outputs the data of the display screen for specifying the individual estimation model used to estimate the content of the data to be estimated, to the terminal device 20.

The model generation unit 18 generates, for example, the estimation model that estimates the content of the data to be estimated from the integrated feature amount. The model generation unit 18 acquires, for example, an integrated feature amount based on data included in the training data. The training data is, for example, the data in which the same type of data as the data to be estimated and the ground truth data having the content of the data are associated. The model generation unit 18 generates the estimation model, by training a relationship between the integrated feature amount generated based on the data included in the training data and the ground truth data. For example, the integrated feature amount is generated similarly to a case where the content of the data to be estimated is estimated. That is, the integrated feature amount used to generate the estimation model is, for example, generated by executing processing for estimating the content of the data included in the training data using the individual estimation model, processing for extracting the additional feature amount from the data included in the training data, and processing for integrating the estimation result by the individual estimation model and the additional feature amount. For example, the model generation unit 18 generates the estimation model related to each individual estimation model.

For example, the model generation unit 18 generates the estimation model by deep learning using the neural network. The model generation unit 18 may generate the estimation model using the decision tree method. The model generation unit 18 may generate the estimation model using the random forest method. A machine learning algorithm used to generate the estimation model is not limited to the above.

For example, the model generation unit 18 generates the integrated model for integrating the estimation results of the plurality of estimation models. The integrated model is generated, for example, by training the relationship between the estimation result of each of the plurality of estimation models and the ground truth data. For example, the model generation unit 18 generates the integrated model by deep learning using the neural network. The machine learning algorithm for generating the integrated model is not limited to the above. The plurality of estimation models and the integrated model may be generated by an information processing device outside the data recognition device 10.

The model generation unit 18 may simultaneously generate the plurality of estimation models and the integrated model. Simultaneously generating means determining parameters of the plurality of estimation models and a parameter of the integrated model at the same timing. For example, the model generation unit 18 generates the plurality of estimation models and the integrated model, by training the relationship between the integrated feature amount and the ground truth data, using the integrated feature amount as an input for each of the plurality of estimation models and an output of each of the plurality of estimation models as an input for the integrated model. For example, the model generation unit 18 saves the plurality of generated models and the generated integrated model in the storage unit 19.

The storage unit 19 saves data regarding processing for estimating the content of the data. For example, the storage unit 19 saves the estimation result of the content of the data. For example, the storage unit 19 saves the estimation result of each individual estimation model. For example, the storage unit 19 saves the additional feature amount extracted from the data to be estimated. For example, the storage unit 19 saves the integrated feature amount. For example, the storage unit 19 saves the estimation result of each of the plurality of estimation models. For example, the storage unit 19 saves the integrated estimation result.

For example, the storage unit 19 saves the individual estimation model. For example, the storage unit 19 saves the estimation model. For example, the storage unit 19 saves the extraction model. For example, the storage unit 19 saves the integrated model. The individual estimation model, the estimation model, the extraction model, and the integrated model may be saved in storage means outside the data recognition device 10. In a case where the model generation unit 18 generates the estimation model and the integrated model, the storage unit 19 saves, for example, the training data.

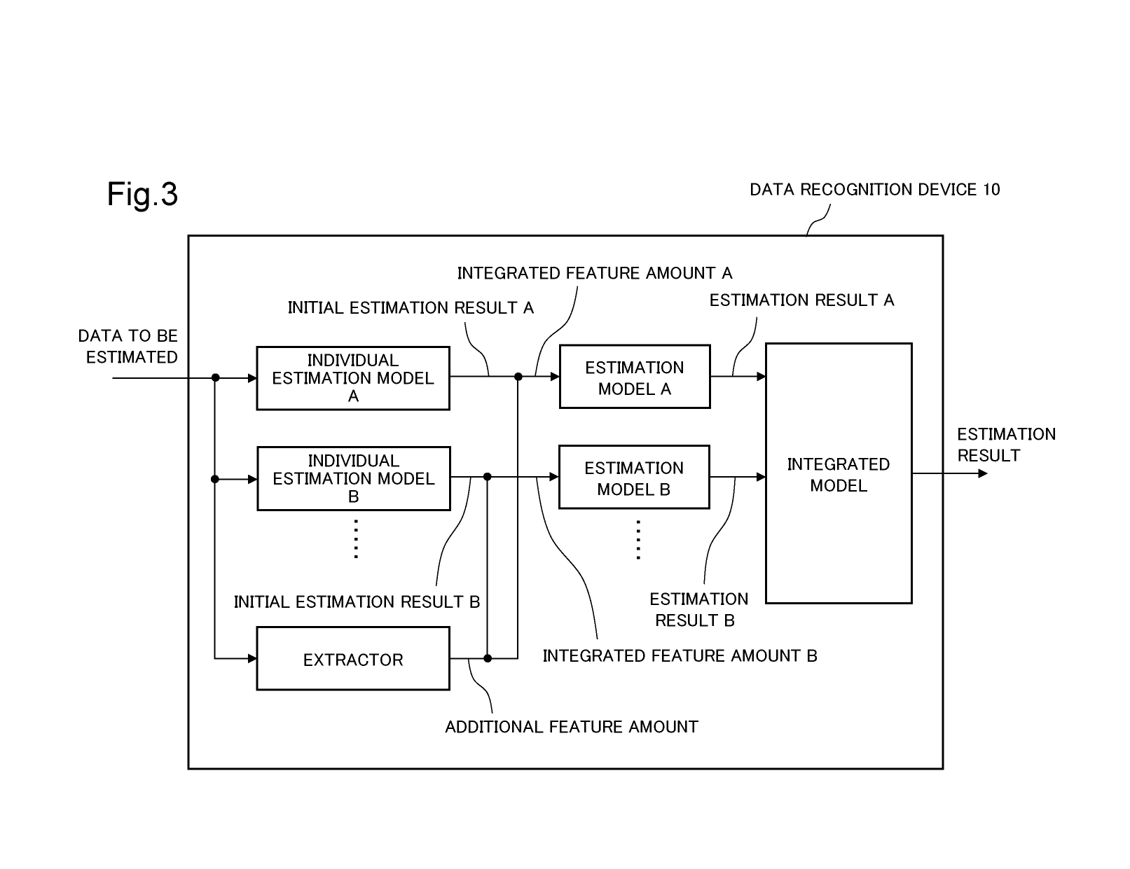

FIG. 3 is a diagram schematically illustrating an example of a data flow in a case where the data recognition device 10 estimates the content of the data. The data to be estimated is, for example, input to each individual estimation model that operates in the individual estimation unit 12. For example, the individual estimation model estimates content of the input data and outputs the estimation result as the initial estimation result. In the example in FIG. 3, the data to be estimated is input to the individual estimation models A and B. In the example in FIG. 3, the individual estimation models A and B estimate the content of the input data to be estimated and output the initial estimation results A and B. In the example in FIG. 3, the extractor that operates in the extraction unit 13 extracts the additional feature amount from the data to be estimated.

The initial estimation result and the additional feature amount are used to generate the integrated feature amount, for example, by the feature amount generation unit 14. In the example in FIG. 3, the integrated feature amount A is generated from the initial estimation result A and the additional feature amount. In the example in FIG. 3, the integrated feature amount B is generated from the initial estimation result B and the additional feature amount. Each generated integrated feature amount is input to the estimation model that operates in the estimation unit 15, for example. In the example in FIG. 3, the integrated feature amount A is input to the estimation model A. In the example in FIG. 3, the integrated feature amount B is input to the estimation model B. For example, the estimation model estimates the content of the data to be estimated from the input integrated feature amount and outputs the estimation result. In the example in FIG. 3, the estimation model A estimates the content of the data to be estimated using the integrated feature amount A as an input and outputs the estimation result A. In the example in FIG. 3, the estimation model B estimates the content of the data to be estimated, using the integrated feature amount B as an input and outputs the estimation result B.

Each estimation result output from each estimation model is, for example, input to the integrated model that operates in the estimation result integration unit 16. Then, the integrated model integrates the estimation results of the plurality of estimation models and outputs the integrated estimation result. In the example in FIG. 3, the integrated model integrates the estimation results of the content of the data to be estimated, using the estimation results A and B as inputs.

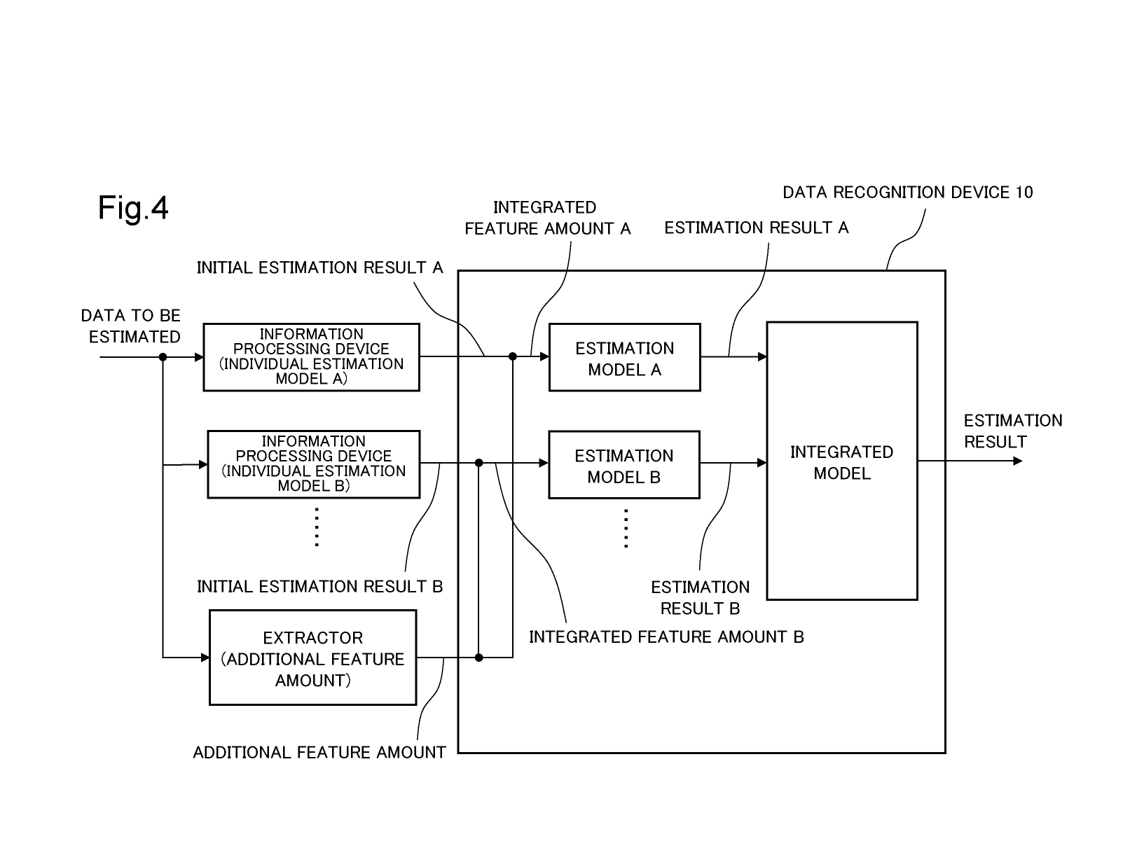

FIG. 4 is a diagram schematically illustrating an example of a data flow in a case where the estimation of the content of the data by the individual estimation model and the extraction of the feature amount are performed by the information processing device outside the data recognition device 10. The data to be estimated is input to the information processing device in which each individual estimation model operates. In each information processing device, for example, the individual estimation model estimates content of input data and outputs an estimation result as an initial estimation result. In the example in FIG. 4, the data to be estimated is input to an information processing device in which the individual estimation model A operates and an information processing device in which the individual estimation model B operates. In the example in FIG. 4, the information processing devices in which the individual estimation models A and B operate output the result obtained by estimating the content of the input data to be estimated by the individual estimation model, as the initial estimation results A and B. In the example in FIG. 4, the data to be estimated is input to the extractor, and the additional feature amount is extracted from the data to be estimated. The extractor is, for example, an information processing device that executes processing for extracting the additional feature amount from the data to be estimated. The extractor may be a sensor that measures characteristics of an estimation target.

In the example in FIG. 4, the initial estimation result output from the information processing device in which the individual estimation model operates and the additional feature amount output from the extractor are input to the data recognition device 10. The initial estimation result and the additional feature amount input to the data recognition device 10 are used to generate the integrated feature amount, for example, by the feature amount generation unit 14. In the example in FIG. 4, the integrated feature amount A is generated from the initial estimation result A and the additional feature amount. In the example in FIG. 4, the integrated feature amount B is generated from the initial estimation result B and the additional feature amount. Each generated integrated feature amount is input to the estimation model that operates in the estimation unit 15, for example. In the example in FIG. 4, the integrated feature amount A is input to the estimation model A. In the example in FIG. 4, the integrated feature amount B is input to the estimation model B. For example, the estimation model estimates the content of the data to be estimated from the input integrated feature amount and outputs the estimation result. In the example in FIG. 4, the estimation model A estimates the content of the data to be estimated using the integrated feature amount A as an input and outputs the estimation result A. In the example in FIG. 4, the estimation model B estimates the content of the data to be estimated, using the integrated feature amount B as an input and outputs the estimation result B.

Each estimation result output from each estimation model is, for example, input to the integrated model that operates in the estimation result integration unit 16. Then, the integrated model integrates the estimation results of the plurality of estimation models and outputs the integrated estimation result. In the example in FIG. 4, the integrated model integrates the estimation results of the content of the data to be estimated, using the estimation results A and B as inputs.

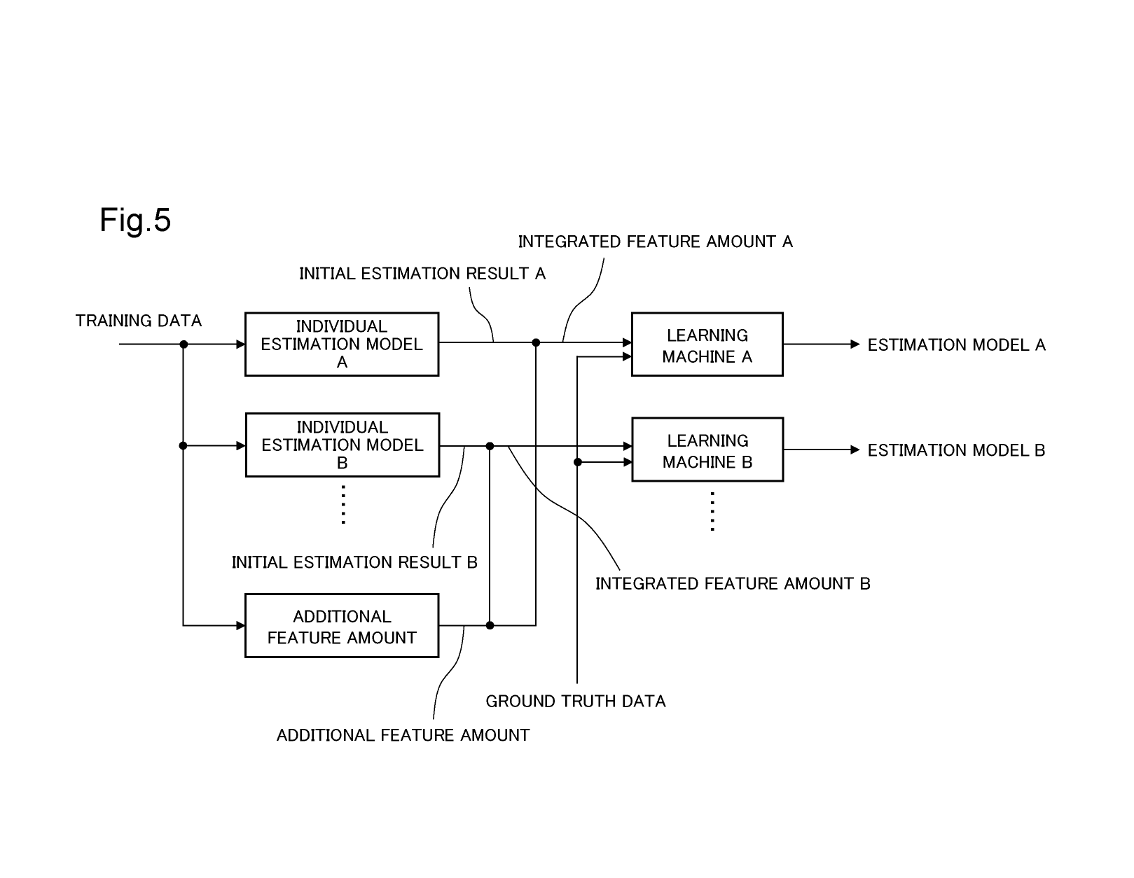

FIG. 5 is a diagram schematically illustrating an example of a data flow in a case where the data recognition device 10 generates the estimation model. Among the training data used to generate the estimation model, the data to be estimated is, for example, input to each individual estimation model that operates in the individual estimation unit 12. For example, the individual estimation model estimates content of the input data and outputs the estimation result as the initial estimation result. In the example in FIG. 5, the data to be estimated is input to the individual estimation models A and B. In the example in FIG. 5, the individual estimation models A and B estimate the content of the input data to be estimated and output the initial estimation results A and B. In the example in FIG. 5, the extractor that operates in the extraction unit 13 extracts the additional feature amount from the data to be estimated.

The initial estimation result and the additional feature amount are used to generate the integrated feature amount, for example, by the feature amount generation unit 14. In the example in FIG. 5, the integrated feature amount A is generated from the initial estimation result A and the additional feature amount. In the example in FIG. 5, the integrated feature amount B is generated from the initial estimation result B and the additional feature amount.

Each generated integrated feature amount is input, for example, to a learning machine that operates in the model generation unit 18. In the example in FIG. 5, the integrated feature amount A is input to a learning machine A. The learning machine A is, for example, a learning machine that generates the estimation model A. In the example in FIG. 5, the integrated feature amount B is input to a learning machine B. The learning machine B is, for example, a learning machine that generates the estimation model B. To each learning machine, the ground truth data associated with the data to be estimated related to the integrated feature amount is input. For example, the learning machine generates the estimation model by training the relationship between the integrated feature amount and the ground truth data. In the example in FIG. 5, for example, the learning machine A trains a relationship between the integrated feature amount A and the ground truth data and generates the estimation model A. In the example in FIG. 5, for example, the learning machine B trains a relationship between the integrated feature amount B and the ground truth data and generates the estimation model B. The generated estimation model is saved, for example, in the storage unit 19.

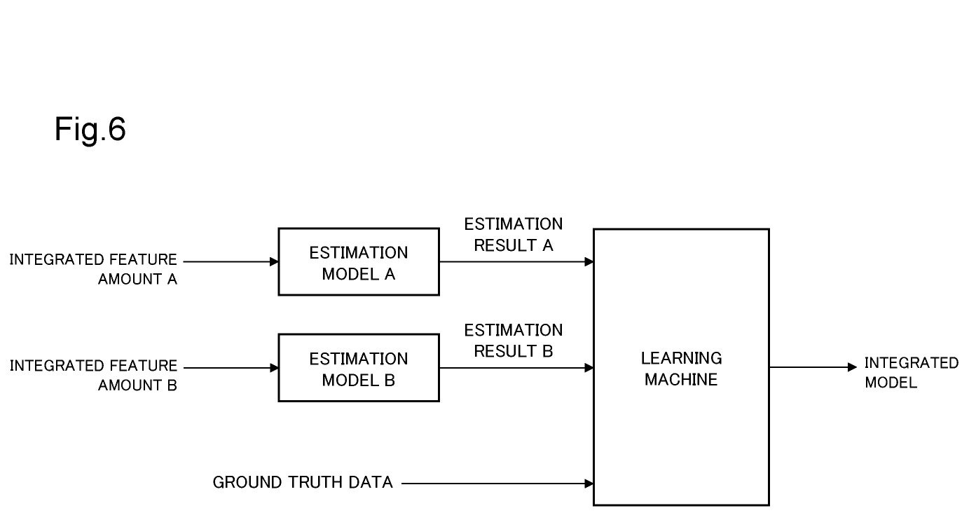

FIG. 6 is a diagram schematically illustrating an example of a data flow in a case where the integrated model is generated. In the example in FIG. 6, for example, the integrated feature amount generated similarly to the generation of the estimation model in the example in FIG. 5 is input to the estimation model that operates in the estimation unit 15. Then, for example, the estimation model estimates the content of the data to be estimated included in the training data from the integrated feature amount and outputs the estimation result.

In the example in FIG. 6, the integrated feature amount A is input to the estimation model A. Then, the estimation model A estimates the content of the data to be estimated and outputs the estimation result A. In the example in FIG. 6, the integrated feature amount B is input to the estimation model B. Then, the estimation model B estimates the content of the data to be estimated and outputs the estimation result B.

Each estimation result is input to, for example, the learning machine that operates in the model generation unit 18. The learning machine is, for example, a learning machine that generates the integrated model. Estimation results based on the same training data are input to the learning machine in association with each other. The estimation result is input to the learning machine, for example, in association with the ground truth data included in the training data. The learning machine trains the relationship between the plurality of estimation results and the ground truth data and generates the integrated model. In the example in FIG. 6, the learning machine trains a relationship between the estimation results A and B and the ground truth data and generates the integrated model. The generated integrated model is saved, for example, in the storage unit 19.

Each processing in the data recognition device 10 may be executed in a distributed manner in a plurality of information processing devices connected via a network. For example, the processing of the feature amount generation unit 14 and the estimation unit 15 and the processing of the estimation result integration unit 16 may be executed in different information processing devices. For example, the processing of the feature amount generation unit 14 and the processing of the estimation unit 15 and the estimation result integration unit 16 may be executed in different information processing devices. Which of the plurality of information processing devices performs each processing in the data recognition device 10 can be appropriately set.

The terminal device 20 is, for example, an information processing device used by the user who uses the estimation result of the content of the data. For example, the user acquires and browses the estimation result, by operating the terminal device 20. The terminal device 20 acquires, for example, the integrated estimation result, from the output unit 17 of the data recognition device 10. Then, the terminal device 20 outputs the integrated estimation result, for example, to a display device (not illustrated).

In a case where the individual estimation model used to estimate the content of the data to be estimated is specified, among the plurality of individual estimation models, for example, the terminal device 20 acquires the data of the display screen for specifying the individual estimation model used to estimate the content of the data to be estimated, from the output unit 17 of the data recognition device 10. The terminal device 20 outputs the display screen for specifying the individual estimation model used to estimate the content of the data to be estimated, for example, to a display device (not illustrated). For example, the terminal device 20 acquires the information for specifying the individual estimation model used to estimate the content of the data to be estimated input by the user’s operation. Then, for example, the terminal device 20 outputs the information for specifying the individual estimation model used to estimate the content of the data to be estimated, to the acquisition unit 11 of the data recognition device 10.

As the terminal device 20, for example, a personal computer, a tablet computer, a smartphone, or a smartwatch can be used. The information processing device used for the terminal device 20 is not limited to the above.

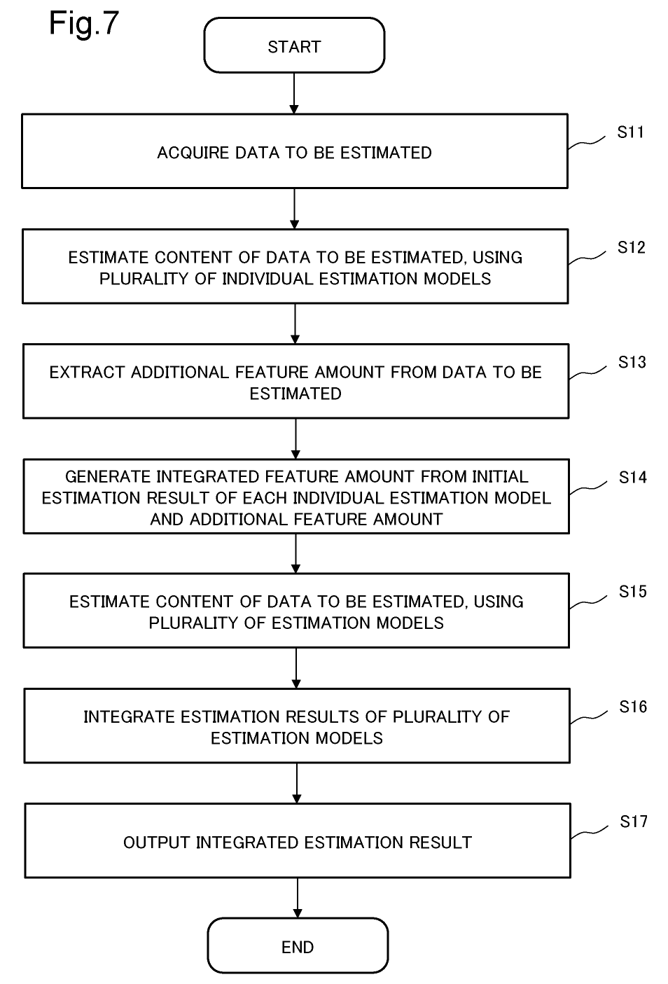

An operation for estimating the content of the data to be estimated by the data recognition device 10 will be described. FIG. 7 is an example of an operation flow in the processing for estimating the content of the data to be estimated by the data recognition device 10.

For example, the acquisition unit 11 acquires the data to be estimated (step S11).

When the data to be estimated is acquired, the individual estimation unit 12 estimates the content of the data to be estimated, for example, using the plurality of individual estimation models (step S12).

When the content of the data to be estimated is estimated, the extraction unit 13 extracts, for example, the additional feature amount from the data to be estimated (step S13).

When the additional feature amount is extracted, the feature amount generation unit 14 generates the integrated feature amount that is the feature amount obtained by integrating the initial estimation result that is the estimation result by each individual estimation model for estimating the content of the data to be estimated and the additional feature amount that is the feature amount extracted from the data to be estimated (step S14).

When the integrated feature amount is generated, the estimation unit 15 estimates the content of the data to be estimated, from the integrated feature amount generated based on the initial estimation result of the individual estimation model related to each of the plurality of estimation models, using the plurality of estimation models for estimating the content of the data to be estimated from the integrated feature amount (step S15).

When each of the plurality of estimation models estimates the content of the data to be estimated, the estimation result integration unit 16 integrates the estimation results of the plurality of estimation models (step S16).

When the estimation results are integrated, the output unit 17 outputs the integrated estimation result (step S17). The output unit 17 outputs the integrated estimation result, for example, to the terminal device 20.

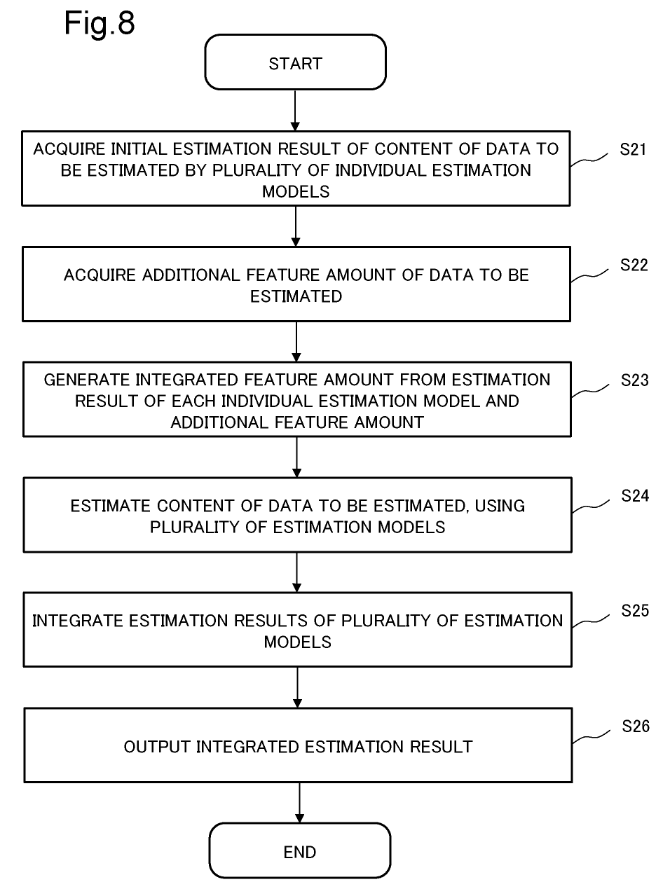

Next, an operation for estimating the content of the data to be estimated by the data recognition device 10 in a case where the estimation by the individual estimation model is performed in the information processing device outside the data recognition device 10 will be described. FIG. 8 is an example of an operation flow in the processing for estimating the content of the data to be estimated by the data recognition device 10, in a case where the estimation by the individual estimation model is performed in the information processing device outside the data recognition device 10.

For example, the individual estimation unit 12 acquires the estimation result of the content of the data to be estimated by the plurality of individual estimation models (step S21). The individual estimation unit 12 acquires the estimation result of the content of the data to be estimated by the individual estimation model, for example, from each of the information processing devices in which the plurality of individual estimation models operates.

When the estimation result of the content of the data to be estimated by the individual estimation model is acquired, for example, the extraction unit 13 acquires the additional feature amount of the data to be estimated (step S22). The extraction unit 13 acquires the additional feature amount of the data to be estimated, for example, from the extractor that extracts the feature amount from the data to be estimated.

When the additional feature amount of the data to be estimated is acquired, the feature amount generation unit 14 generates the integrated feature amount that is the feature amount obtained by integrating the estimation result of each individual estimation model for estimating the content of the data to be estimated and the additional feature amount that is the feature amount extracted from the data to be estimated (step S23).

When the integrated feature amount is generated, the estimation unit 15 estimates the content of the data to be estimated, from the integrated feature amount generated based on the estimation result of the individual estimation model related to each of the plurality of estimation models, using the plurality of estimation models for estimating the content of the data to be estimated from the integrated feature amount (step S24).

When the content of the data to be estimated is estimated, the estimation result integration unit 16 integrates the estimation results of the plurality of estimation models (step S25).

When the estimation results are integrated, the output unit 17 outputs the integrated estimation result (step S26).

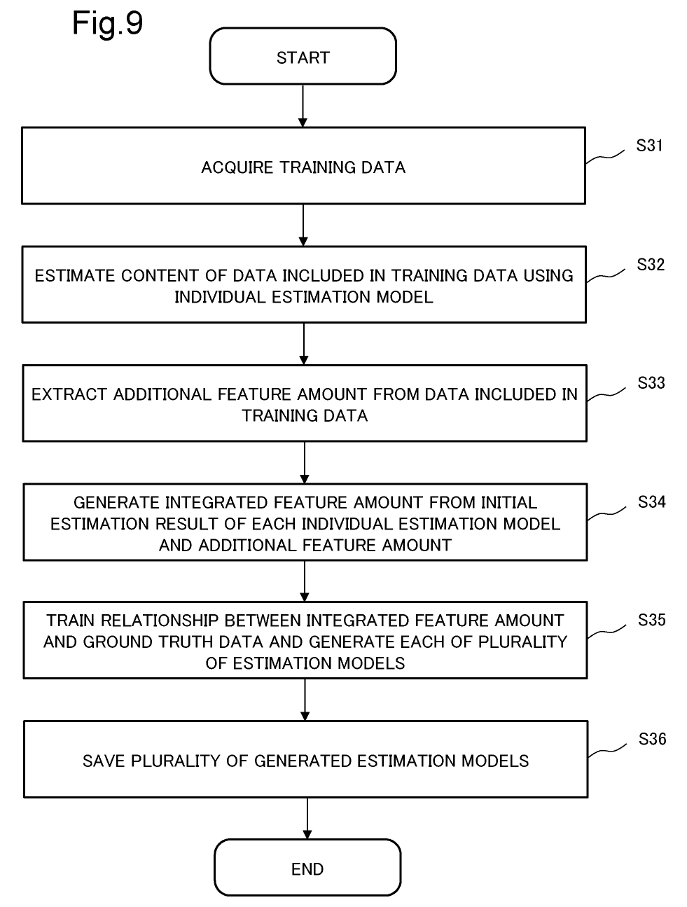

Next, an operation, by the data recognition device 10, for generating the estimation model that estimates the content of the data to be estimated will be described. FIG. 9 is an example of an operation flow in the processing for generating the estimation model that estimates the content of the data to be estimated, by the data recognition device 10.

For example, the acquisition unit 11 acquires the training data used to generate the estimation model (step S31). The training data is, for example, data in which the same type of data as the data to be estimated by the estimation model is associated with the ground truth data of the data.

When the training data is acquired, for example, the individual estimation unit 12 estimates the content of the data included in the training data, using the individual estimation model related to the generated estimation model (step S32).

When the content of the data included in the training data is estimated, for example, the extraction unit 13 extracts the additional feature amount from the data included in the training data (step S33).

When the additional feature amount is extracted, for example, the feature amount generation unit 14 generates the integrated feature amount from the estimation result of the content of the data included in the training data by the individual estimation model and the additional feature amount extracted from the data (step S34).

When the integrated feature amount is extracted, for example, the model generation unit 18 trains the relationship between the integrated feature amount and the ground truth data and generates each of the plurality of estimation models (step S35).

When each of the plurality of estimation models is generated, for example, the model generation unit 18 saves the plurality of generated estimation models. For example, the model generation unit 18 saves the plurality of generated estimation models in the storage unit 19 (step S36).

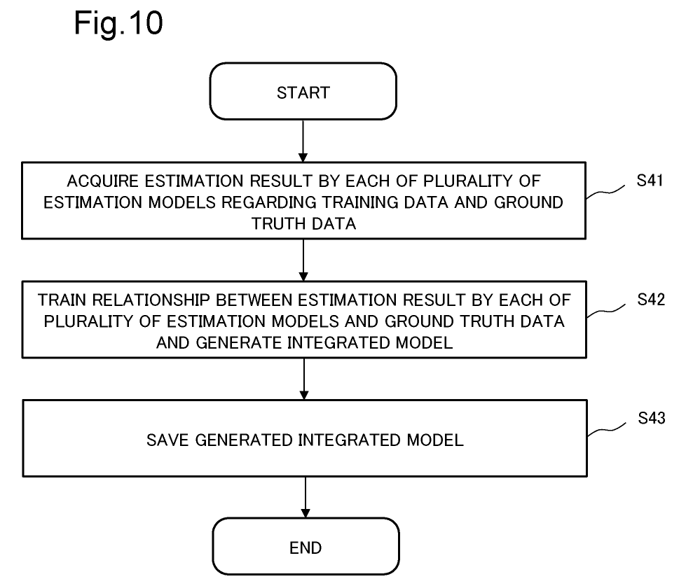

Next, an operation, by the data recognition device 10, for generating the integrated model that integrates the estimation results by the plurality of estimation models will be described. FIG. 10 is an example of an operation flow in the processing for generating the integrated model that integrates the estimation results by the plurality of estimation models, by the data recognition device 10.

For example, the acquisition unit 11 acquires an estimation result by each of the plurality of estimation models regarding the training data and the ground truth data (step S41). For example, the acquisition unit 11 acquires the estimation result of the content of the data included in the training data by each estimation model performed at the time of generating the estimation model, as the estimation result regarding the training data.

When the estimation result and the ground truth data are acquired, for example, the model generation unit 18 trains the relationship between the estimation result by each of the plurality of estimation models and the ground truth data and generates the integrated model (step S42).

When the integrated model is generated, for example, the model generation unit 18 saves the generated integrated model (step S43). For example, the model generation unit 18 saves the generated integrated model in the storage unit 19.

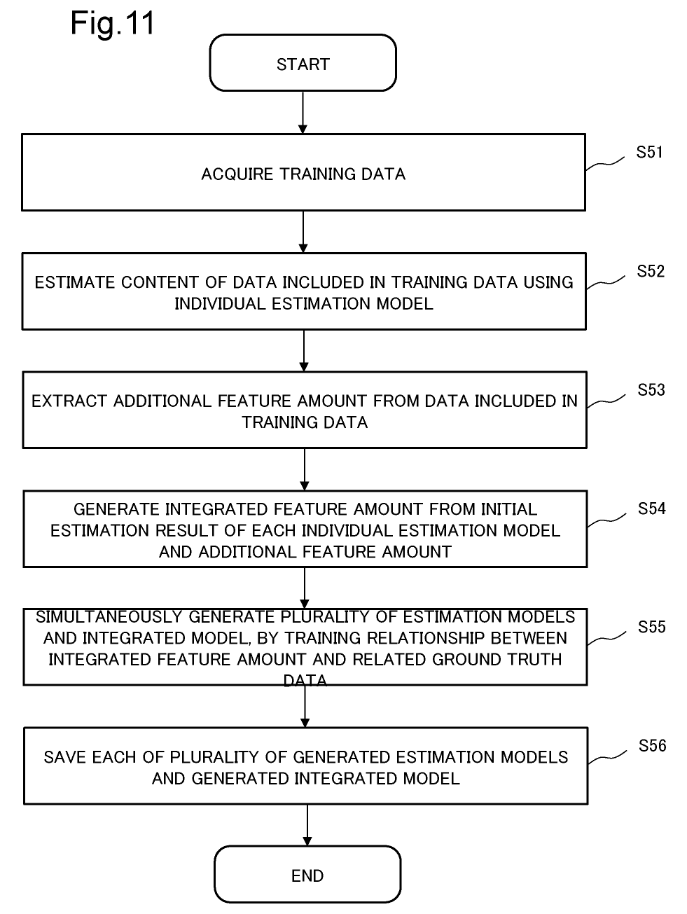

Next, an operation, by the data recognition device 10, for simultaneously generating the estimation model that estimates the content of the data to be estimated and the integrated model that integrates the estimation result by the estimation model will be described. FIG. 11 is an example of an operation flow in the processing for simultaneously generating the estimation model that estimates the content of the data to be estimated and the integrated model that integrates the estimation result, by the estimation model by the data recognition device 10.

For example, the acquisition unit 11 acquires the training data used to generate the estimation model (step S51). The training data is, for example, data in which the same type of data as the data of which the content is estimated and the ground truth data of the data are associated with each other.

When the training data is acquired, for example, the individual estimation unit 12 estimates the content of the data included in the training data, using the individual estimation model related to the generated estimation model (step S52).

When the content of the data included in the training data is estimated, for example, the extraction unit 13 extracts the additional feature amount from the data included in the training data (step S53).

When the additional feature amount is extracted, for example, the feature amount generation unit 14 generates the integrated feature amount from the estimation result of the content of the data included in the training data by the individual estimation model and the additional feature amount extracted from the data (step S54).

When the integrated feature amount is generated, the model generation unit 18 simultaneously generates the plurality of estimation models and the integrated model, by training the relationship between the integrated feature amount and the related ground truth data (step S55).

When each of the plurality of estimation models and the integrated model are generated, for example, the model generation unit 18 saves the plurality of generated estimation models and the generated integrated model (step S56). For example, the model generation unit 18 saves the plurality of generated estimation models and the integrated model, in the storage unit 19.

The data recognition device 10 generates the integrated feature amount obtained by integrating the estimation result by each individual estimation model and the additional feature amount extracted from the data to be estimated. The data recognition device 10 estimates the content of the data to be estimated, from the integrated feature amount generated based on the estimation result of the individual estimation model related to each of the plurality of estimation models, using the plurality of estimation models. Then, the estimation result integration unit 16 integrates the estimation results of the plurality of estimation models. In this way, by integrating the estimation results of the content of the data respectively estimated from the plurality of integrated feature amounts, the data recognition device 10 can improve accuracy of the data content estimation.

By estimating the content of the data based on the integrated feature amount generated from the estimation result of the individual estimation model and the additional feature amount, the data recognition device 10 can accurately estimate the content of the data, for example. By estimating the content of the data based on the integrated feature amount generated from the estimation result of the individual estimation model and the additional feature amount, for example, the data recognition device 10 can combine the individual estimation models for performing estimation in different forms and estimate the content of the data. Therefore, even in a case where the content of the data is finely different, the data recognition device 10 can accurately estimate the content of the data.

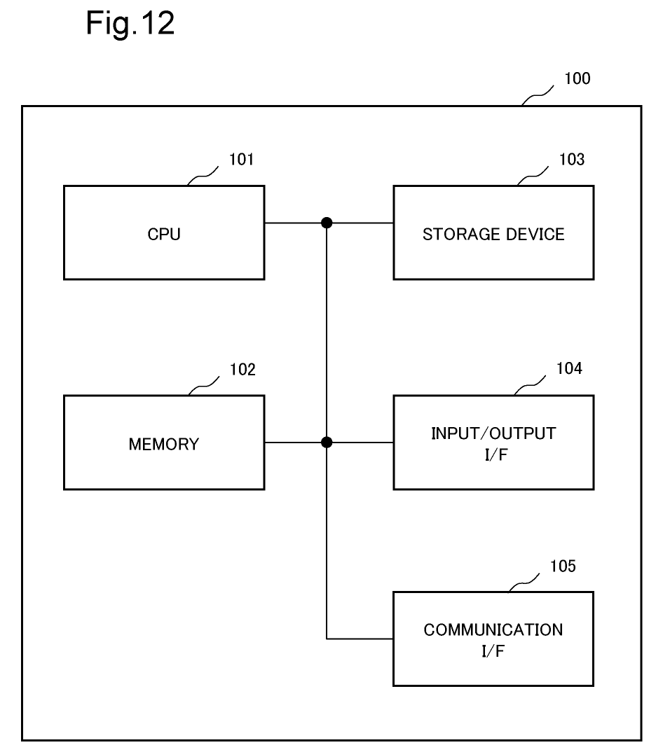

Each processing in the data recognition device 10 can be implemented by executing a computer program on a computer. FIG. 12 illustrates an example of a configuration of a computer 100 that executes a computer program for executing each processing in the data recognition device 10. The computer 100 includes a Central Processing Unit (CPU) 101, a memory 102, a storage device 103, an input/output Interface (I/F) 104, and a communication I/F 105.

The CPU 101 reads and executes the computer program for executing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a Graphics Processing Unit (GPU). The memory 102 includes a Dynamic Random Access Memory (DRAM) or the like and temporarily stores the computer program executed by the CPU 101 and data being processed. The storage device 103 stores the computer program executed by the CPU 101. The storage device 103 includes, for example, a non-volatile semiconductor storage device. As the storage device 103, another storage device such as a hard disk drive may be used. The input/output I/F 104 is an interface that receives an input from a worker and outputs display data and the like. The communication I/F 105 is an interface for transmitting and receiving data to and from the terminal device 20. The terminal device 20 may have a configuration similar to that of the computer 100.

The computer program used for executing each processing can also be distributed by being stored in a computer-readable recording medium that non-transiently records data. As the recording medium, for example, a magnetic tape for data recording or a magnetic disk such as a hard disk can be used. As the recording medium, an optical disk such as a Compact Disc Read Only Memory (CD-ROM) can also be used. A non-volatile semiconductor storage device may be used as the recording medium.

Data recognition using a machine learning model has been widely used in character recognition, video analysis, individual identification, or the like. The data recognition has been widely used, and a demand for accuracy of a result of the data recognition has also increased. As a method for improving the accuracy of the result of the data recognition, for example, a method for recognizing data using a plurality of machine learning models may be used.

An inference device in JP 2023-156633 A extracts a plurality of feature amounts from an image to be identified and identifies the image based on each of the plurality of feature amounts. Then, the inference device in JP 2023-156633 A integrates a plurality of identification results.

There is a case where it is difficult for a technique described in JP 2023-156633 A to improve data recognition accuracy.

According to the present disclosure, it is possible to improve data recognition accuracy.

Some or all of the above-described example embodiments may be described as the following Supplementary Notes, but are not limited to the following Supplementary Notes.

### Supplementary Note 1

A data recognition device including:

feature amount generation unit that generates an integrated feature amount that is a feature amount obtained by integrating an initial estimation result that is an estimation result by each individual estimation model that estimates content of data to be estimated and an additional feature amount that is a feature amount extracted from the data to be estimated;

estimation unit that estimates the content of the data to be estimated, from the integrated feature amount generated based on the initial estimation result of the individual estimation model related to each of a plurality of estimation models, using the plurality of estimation models that estimates the content of the data to be estimated from the integrated feature amount;

estimation result integration unit that integrates estimation results of the plurality of estimation models; and

output unit that outputs the integrated estimation result.

### Supplementary Note 2

The data recognition device according to supplementary note 1, in which

the feature amount generation unit generates the integrated feature amount using a feature amount extracted at an intermediate stage of the estimation by the individual estimation model as the additional feature amount.

### Supplementary Note 3

The data recognition device according to supplementary note 1, in which

the feature amount generation unit generates the integrated feature amount by integrating the same additional feature amount with the estimation result of each individual estimation model.

### Supplementary Note 4

The data recognition device according to any one of supplementary notes 1 to 3, in which

the respective individual estimation models are generated using algorithms different from each other.

### Supplementary Note 5

The data recognition device according to any one of supplementary notes 1 to 3, in which

the estimation result integration unit integrates the estimation results of the plurality of estimation models by specifying the content of the data to be estimated from the estimation result of each of the plurality of estimation models, using an integrated model that specifies content of data from the estimation result of each of the plurality of estimation models.

### Supplementary Note 6

The data recognition device according to supplementary note 5, further including:

model generation unit that generates the plurality of estimation models and the integrated model, by training a relationship between the integrated feature amount and ground truth data of the content of the data to be estimated.

### Supplementary Note 7

The data recognition device according to any one of supplementary notes 1 to 3, in which

the output unit further outputs a reason for estimating the content of the data.

### Supplementary Note 8

The data recognition device according to any one of supplementary notes 1 to 3, in which

the additional feature amount is a feature amount regarding classification of the data to be estimated by the individual estimation model or characteristics.

### Supplementary Note 9

The data recognition device according to any one of supplementary notes 1 to 3, further including:

model generation unit that generates an estimation model by training a relationship between the integrated feature amount and ground truth data of the content of the data to be estimated.

### Supplementary Note 10

The data recognition device according to supplementary note 5, further including:

generation unit that generates the integrated model by training a relationship between the estimation result by each of the plurality of estimation models and ground truth data of the content of the data to be estimated.

### Supplementary Note 11

The data recognition device according to supplementary note 7, in which

the output unit outputs the reason for estimating the content of the data, based on a part focused by the individual estimation model in the estimation.

### Supplementary Note 12

The data recognition device according to any one of supplementary notes 1 to 3, further including:

acquisition unit that acquires the data to be estimated;

individual estimation unit that estimates the content of the data to be estimated acquired by the acquisition unit as the initial estimation result, using the plurality of individual estimation models that estimate the content of the data to be estimated; and

extraction unit that extracts a feature amount, as the additional feature amount, from the data to be estimated acquired by the acquisition unit, in which

the feature amount generation unit generates the integrated feature amount, based on each estimated initial estimation result and the extracted additional feature amount.

### Supplementary Note 13

The data recognition device according to any one of supplementary notes 1 to 3, further including:

acquisition unit that acquires the data to be estimated and the initial estimation result that is the estimation result by each individual estimation model that estimates the content of the data to be estimated; and

extraction unit that extracts a feature amount, as the additional feature amount, from the data to be estimated acquired by the acquisition unit, in which

the feature amount generation unit generates the integrated feature amount, based on each acquired initial estimation result and the extracted additional feature amount.

### Supplementary Note 14

A data recognition method including:

generating an integrated feature amount that is a feature amount obtained by integrating an initial estimation result that is an estimation result by each individual estimation model that estimates content of data to be estimated and an additional feature amount that is a feature amount extracted from the data to be estimated;

estimating the content of the data to be estimated, from the integrated feature amount generated based on the initial estimation result of the individual estimation model related to each of a plurality of estimation models, using the plurality of estimation models that estimates the content of the data to be estimated from the integrated feature amount;

integrating estimation results of the plurality of estimation models; and

outputting the integrated estimation result.

### Supplementary Note 15

A non-transitory recording medium recording a program for causing a computer to execute:

processing for generating an integrated feature amount that is a feature amount obtained by integrating an initial estimation result that is an estimation result by each individual estimation model that estimates content of data to be estimated and an additional feature amount that is a feature amount extracted from the data to be estimated;

processing for estimating the content of the data to be estimated, from the integrated feature amount generated based on the initial estimation result of the individual estimation model related to each of a plurality of estimation models, using the plurality of estimation models that estimates the content of the data to be estimated from the integrated feature amount;

processing for integrating estimation results of the plurality of estimation models; and

processing for outputting the integrated estimation result.

Some or all of the configurations described in Supplementary Notes 2 to 13 dependent on above-described Supplementary Note 1 can also be dependent on Supplementary Notes 14 and 15 by a dependency subordinate relationship similar to that of Supplementary Notes 2 to 13. Some or all of the configurations described as the Supplementary Notes can be similarly dependent on not only the Supplementary Notes 1, 14, and 15, but also various pieces of hardware and software, a variety of recording means for recording software, and systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A data recognition device comprising:
at least one memory storing instructions; and
at least one processor configured to access the at least one memory and execute the instructions to:
generate an integrated feature amount that is a feature amount obtained by integrating an initial estimation result that is an estimation result by each individual estimation model that estimates content of data to be estimated and an additional feature amount that is a feature amount extracted from the data to be estimated;
estimate the content of the data to be estimated, from the integrated feature amount generated based on the initial estimation result of the individual estimation model related to each of a plurality of estimation models, using the plurality of estimation models that estimates the content of the data to be estimated from the integrated feature amount;
integrate estimation results of the plurality of estimation models; and
output the integrated estimation result.

2. The data recognition device according to claim 1, wherein
the at least one processor is further configured to execute the instructions to:
generate the integrated feature amount using a feature amount extracted at an intermediate stage of the estimation by the individual estimation model as the additional feature amount.

3. The data recognition device according to claim 1, wherein
the at least one processor is further configured to execute the instructions to:
generate the integrated feature amount by integrating the same additional feature amount with the estimation result of each individual estimation model.

4. The data recognition device according to claim 1, wherein
the respective individual estimation models are generated using algorithms different from each other.

5. The data recognition device according to claim 1, wherein
the at least one processor is further configured to execute the instructions to:
integrate the estimation results of the plurality of estimation models by specifying the content of the data to be estimated from the estimation result of each of the plurality of estimation models, using an integrated model that specifies content of data from the estimation result of each of the plurality of estimation models.

6. The data recognition device according to claim 5, wherein
the at least one processor is further configured to execute the instructions to:
generate the plurality of estimation models and the integrated model, by training a relationship between the integrated feature amount and ground truth data of the content of the data to be estimated.

7. The data recognition device according to claim 1, wherein
the at least one processor is further configured to execute the instructions to:
output a reason for estimating the content of the data.

8. The data recognition device according to claim 1, wherein
the additional feature amount is a feature amount regarding classification of the data to be estimated by the individual estimation model or characteristics.

9. The data recognition device according to claim 1, wherein
the at least one processor is further configured to execute the instructions to:
generate an estimation model by training a relationship between the integrated feature amount and ground truth data of the content of the data to be estimated.

10. The data recognition device according to claim 5, wherein
the at least one processor is further configured to execute the instructions to:
generate the integrated model by training a relationship between the estimation result by each of the plurality of estimation models and ground truth data of the content of the data to be estimated.

11. The data recognition device according to claim 7, wherein
the at least one processor is further configured to execute the instructions to:
output the reason for estimating the content of the data, based on a part focused by the individual estimation model in the estimation.

12. The data recognition device according to claim 1, wherein
the at least one processor is further configured to execute the instructions to:
acquire the data to be estimated;
estimate the content of the acquired data to be estimated as the initial estimation result, using the plurality of individual estimation models that estimate the content of the data to be estimated;
extract a feature amount, as the additional feature amount, from the acquired data to be estimated; and
generate the integrated feature amount, based on each estimated initial estimation result and the extracted additional feature amount.

13. The data recognition device according to claim 1, wherein
the at least one processor is further configured to execute the instructions to:
acquire the data to be estimated and the initial estimation result that is the estimation result by each individual estimation model that estimates the content of the data to be estimated; and
extract a feature amount, as the additional feature amount, from the acquired data to be estimated; and
generate the integrated feature amount, based on each acquired initial estimation result and the extracted additional feature amount.

14. A data recognition method comprising:
generating an integrated feature amount that is a feature amount obtained by integrating an initial estimation result that is an estimation result by each individual estimation model that estimates content of data to be estimated and an additional feature amount that is a feature amount extracted from the data to be estimated;
estimating the content of the data to be estimated, from the integrated feature amount generated based on the initial estimation result of the individual estimation model related to each of a plurality of estimation models, using the plurality of estimation models that estimates the content of the data to be estimated from the integrated feature amount;
integrating estimation results of the plurality of estimation models; and
outputting the integrated estimation result.

15. A non-transitory recording medium recording a program for causing a computer to execute:
processing for generating an integrated feature amount that is a feature amount obtained by integrating an initial estimation result that is an estimation result by each individual estimation model that estimates content of data to be estimated and an additional feature amount that is a feature amount extracted from the data to be estimated;
processing for estimating the content of the data to be estimated, from the integrated feature amount generated based on the initial estimation result of the individual estimation model related to each of a plurality of estimation models, using the plurality of estimation models that estimates the content of the data to be estimated from the integrated feature amount;
processing for integrating estimation results of the plurality of estimation models; and
processing for outputting the integrated estimation result.
